(19) United States
(12) Patent Application Publication
(10) Pub. No.: US 2011/0119199 A1
(43) Pub. Date: May 19, 2011

(54) Facility Resource Consumption Estimator

(75) Inventor: Udo Waibel, Los Altos, CA (US)

(73) Assignee: HARA SOFTWARE, INC., Redwood City, CA (US)

(21) Appl. No.: 12/748,095

(22) Filed: Mar. 26, 2010

(51) Int. Cl. G06Q 99/00; G06Q 10/00

(52) U.S. Cl. 705/317

(57) ABSTRACT

A centralized emission management system is implemented via a server that is accessible to a large number of entities. An entity uploads information about demographic data and resource consumption data of its organizational units, such as facilities, to determine measures of environmental impact, such as CO2e emissions. When resource consumption of a target organizational unit is not available, the entity can request the server to estimate the resource consumption based on private information about comparable organizational units within the entity or public information about comparable organizational units outside of the entity. The server determines the comparable organizational units based on the demographic data. The entity can select a resource consumption item of a comparable organizational unit from which the server determines an estimated resource consumption of the target organizational unit, generates an audit trail of the estimate, and determines a measure of environmental impact from the estimate. Any report listing the estimated resource consumption or the measure of environmental impact clearly designates the value as an estimate.

### FIELD OF INVENTION

This present disclosure is related generally to the field of emissions management, such as greenhouse gas (GHG) emissions management, and more specifically to a centralized emission management system that estimates resource consumption at facilities.

### DESCRIPTION OF RELATED ART

“Emissions” refer to the introduction of chemicals, particulate matter, or biological materials into the atmosphere, ground, or water system that potentially can cause harm or discomfort to humans or other living organisms, or may damage the natural environment.

GHG is a collective term for gases such as carbon dioxide, methane, HFCs, SF6, and nitrous oxide that trap heat in the atmosphere and contribute to climate change. GHG accounting and reporting is the discipline of tracking GHGs produced as a result of executing business processes, including manufacturing, travel, keeping of livestock, etc.

The term “carbon dioxide equivalent” (CO2e) is a common normalized unit of measurement, such as expressed in tonnes of CO2e, that is used to compare the relative climate impact of the different GHGs. The CO2e quantity of any GHG is the amount of carbon dioxide that would produce the equivalent global warming potential. There are publicly accepted factors that are used to convert an entity's emissions, usage of resources (e.g., electricity, gas, oil, coal, etc.), or waste products, among other things, into a CO2e emission.

A company or other entity may want to, or be required to, reduce their CO2e emissions or energy usage. For example, a company's CO2e emissions may be capped by a governmental or industrial organization within an established time frame. However, the company may not have all the resource consumption data necessary to calculate its CO2e emissions at all of its facilities. Thus what is needed is a technique to estimate resource consumption at a facility when data from that facility is not available.

### SUMMARY

In one or more embodiments of the present disclosure, a centralized emission management system is implemented via a server that is accessible to a large number of entities. An entity uploads information about demographic data and resource consumption data of its organizational units, such as facilities, to determine measures of environmental impact, such as CO2e emissions. When resource consumption of a target organizational unit is not available, the entity can request the server to estimate the resource consumption based on private information about comparable organizational units within the entity or public information about comparable organizational units outside of the entity. The server determines the comparable organizational units based on the demographic data, such as facility area (e.g., square footage), revenue, produced units, facility type (e.g., office, manufacturing, etc.), facility age, facility operating hours, employee count, HVAC type, facility location, and other demographic data. The entity can select a resource consumption item of a comparable organizational unit from which the server determines an estimated resource consumption of the target organizational unit, generates an audit trail of the estimate, and determines a measure of environmental impact from the estimate. Any report listing the estimated resource consumption or the measure of environmental impact clearly designates the value as an estimate.

### BRIEF DESCRIPTION OF THE DRAWINGS

In the drawings:

FIG. 1 illustrates a web-based emission management system in one or more embodiments of the present disclosure;

FIG. 2 illustrates a flowchart of a method implemented with algorithms executed by a programmed processor in a server of FIG. 1 to estimate resource consumptions at an organizational unit, such as a facility, of a client in one or more embodiments of the present disclosure;

FIG. 3 shows a graphical user interface (GUI) generated by the server of FIG. 1 for the client to submit a request to estimate resource consumption at the organizational unit in one or more embodiments of the present disclosure; and

FIG. 4 shows a GUI generated by the server of FIG. 1 for the client to see a report of resource consumptions at the organizational unit in one or more embodiments of the present disclosure.

Use of the same reference numbers in different figures indicates similar or identical elements.

### DETAILED DESCRIPTION OF THE INVENTION

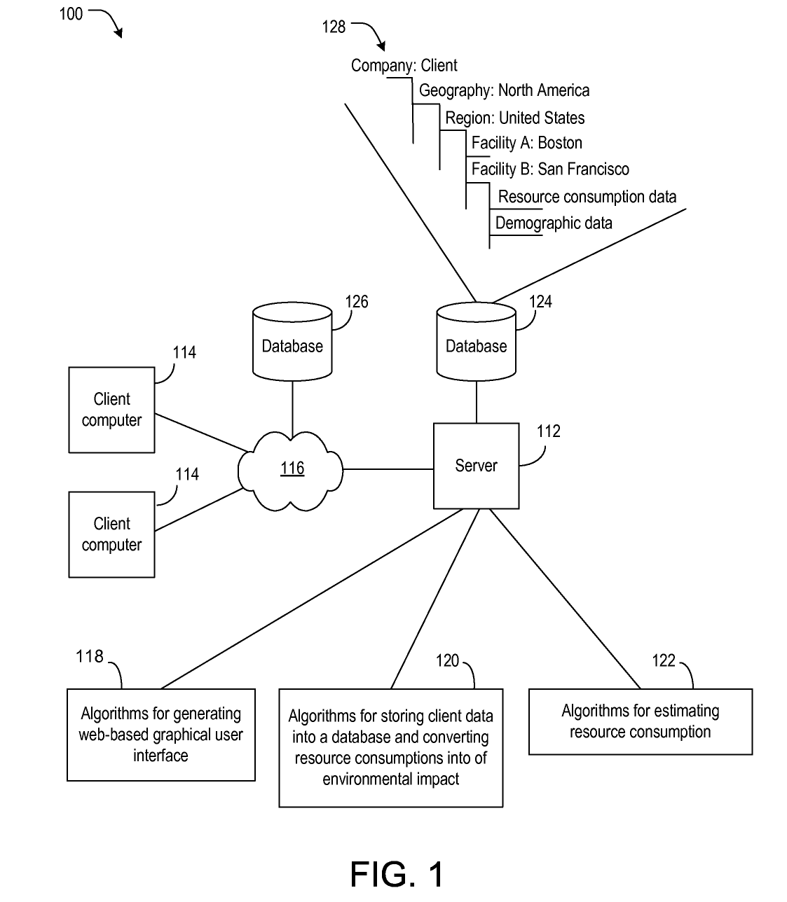

FIG. 1 illustrates a web-based emission management system 100 in one or more embodiments of the present disclosure. A server 112, which may be managed by a host entity, provides a web-based GUI that interacts with the various client entities to allow the clients to upload data to server 112, view information generated by server 112 relating to environmental impact, and allow the clients to interact with the displayed information to develop emission reduction strategies. Server 112 and the clients' computers 114 communicate via a public or private computer network 116, such as the Internet. A client accesses its account using passwords or other methods.

Although server 112 has many functions, and there may be a plurality of servers, only one server and its emission management software related to the present disclosure are illustrated. The emission management software includes algorithms 118, 120, and 122, which are stored along with their data in a non-transitory computer-readable medium. Algorithms 118 are for generating the web-based GUI and related functions. Algorithms 120 are for storing the clients' entered data into a database 124 and converting the clients' resource consumptions and other relevant information into CO2e emissions, wastewater production, and other measures of environmental impact. Algorithms 122 are for estimating resource consumption at an organizational unit, such as a facility, based on demographic data and resource consumption data in database 124 or a public database 126, recording the estimated resource consumption in database 124, and creating an audit trail for the estimated resource consumption.

A client initially sets up its account in the emission management software by providing a company model 128 with a hierarchy of its organizational units via the web-based GUI or an upload of a compatible file with such information. The hierarchical levels of the organizational units may include geographical areas such as continents, regions such as countries in a geographical area, and facilities such as cities in a region. The client then inputs information for each organizational unit using the web-based GUI or an upload of a compatible file with such information. The emission management software is able to present processed information to the client on a per facility basis or aggregated for different hierarchical levels of the company.

The client provides information for each organizational unit relevant to environmental impact. Some of the information may be related to resource consumption of an organizational unit, such as types of energy used (e.g., electricity, natural gas, diesel, oil, coal, etc.), quantities of energy used (e.g., kwh, gallons, etc.), dates of energy used, costs of energy used, airline travel, lighting usage, types/amounts of products manufactured and types/amounts of emissions, efficiencies, waste products, water usage, raw input product usage (e.g., paper, metals, etc.), costs of various pertinent resources, and other types of data pertinent to resource consumption. Server 112 may save the individual resource consumption entries as resource consumption items for the organizational unit in database 124. Some of the information may be related to demographics of the organizational unit, such as facility area (e.g., square footage), facility revenue, facility produced units, facility type (e.g., office, manufacturing, etc.), facility age, facility operating hours, facility employee count, facility HVAC type, facility location, and other types of data pertinent to demographics.

Each input resource and/or output product, assuming a certain usage efficiency, is applied to an appropriate algorithm to determine its corresponding CO2e emission quantity or other unit of measurement. Many of the algorithms 120 correlating resources, outputs, or activities to an equivalent CO2e emission are based on publicly known standards, such as the Emissions & Generation Resource Integrated Database (eGRID) conversion factors used by the Environmental Protection Agency (EPA).

The raw data, e.g. in terms of natural gas or gallons of gasoline, is periodically input by the clients, such as at the end of each accounting period, which may be yearly. The client's data may also include information that is automatically uploaded to the server 112 through any interface, such as a utility meter for electricity, water, etc. Server 112 stores the past data in database 124. Server 112 processes the data and presents the processed data to the client in a suitable presentation on the web-based GUI, upon the client requesting the presentation.

When resource consumption of a target organizational unit/facility is not available, the client can request server 112 to estimate the resource consumption based on comparable organizational units/facilities within the entity or public information about comparable organizational units/facilities outside of the entity. Server 112, executing algorithms 122, determines the comparable facilities based on their demographic data in database 124 and presents them to the client. The client can select a comparable facility, and in response server 112 determines resource consumption items of the selected comparable facility from database 124. The client can select a resource consumption item, and in response server 112 determines an estimated resource consumption of the target facility, generates an audit trail of the estimate, and determines a measure of environmental impact from the estimate. Any report listing the estimated resource consumption or the measure of environmental impact clearly designates the value as an estimate.

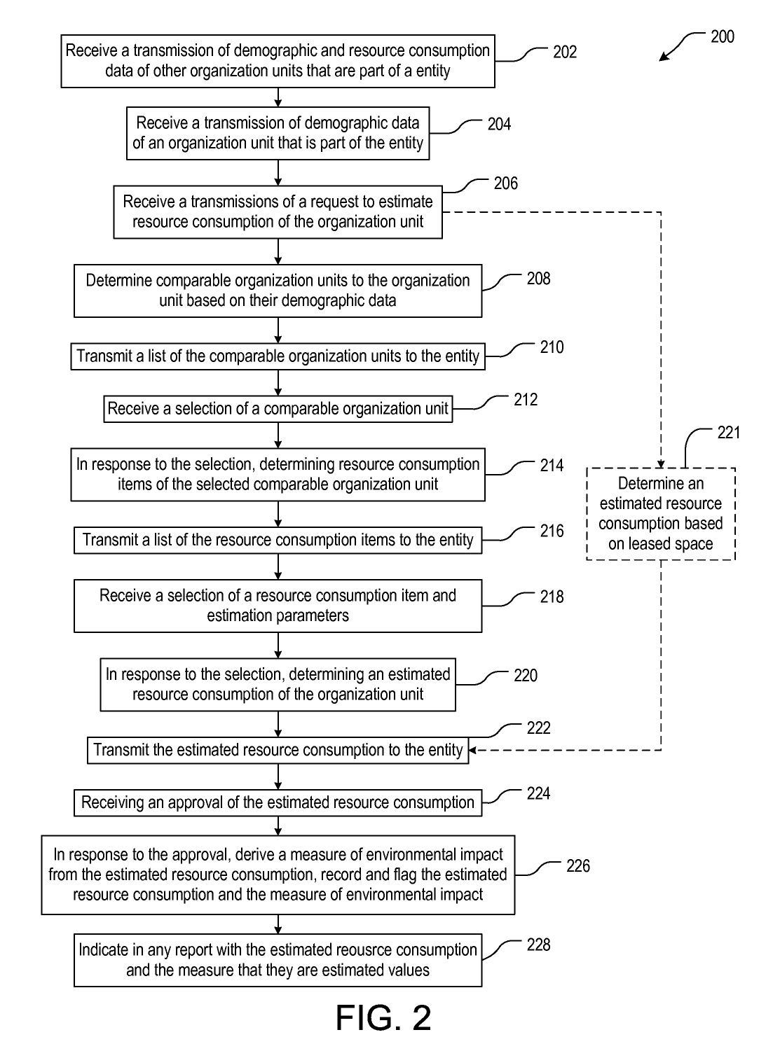

FIG. 2 is a flowchart of a method 200 implemented with algorithms 122 executed by a programmed processor in server 112 to estimate resource consumption at an organizational unit (hereafter “facility A”) of a client in one or more embodiments of the present disclosure. Method 200 may comprise one or more operations, functions or actions as illustrated by one or more of blocks. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Method 200 may begin in block 202 after the client has set up its company model. In block 202, server 112 receives a transmission of demographic data and resource consumption data of other organizational units (hereafter “facilities B”) that are part of the client. The types of demographic data may include but are not limited to facility area, facility revenue, facility produced units, facility type, facility age, facility operating hours, facility employee count, facility HVAC type, and facility location. The types of resource consumption data may include but are not limited to resource consumption types, resource consumption amounts, dates of consumption, indications if information for each resource consumption item is estimated by the client, and resource consumption prices. Server 112 stores the data in database 124. Block 202 may be followed by block 204.

In block 204, server 112 receives a transmission of demographic data of facility A that is part of the client. Server 112 stores the data in database 124. Block 204 may be followed by block 206.

In block 206, server 112 receives a transmission of a request to estimate resource consumption of facility A. The request includes an estimation approach, a resource consumption type, and an estimation period. Depending on the estimation approach, the request includes other information specific to the estimation approach. For example, when a comparable facility estimation approach is selected, the request further includes a normalization factor and demographic filters for determining comparable facilities.

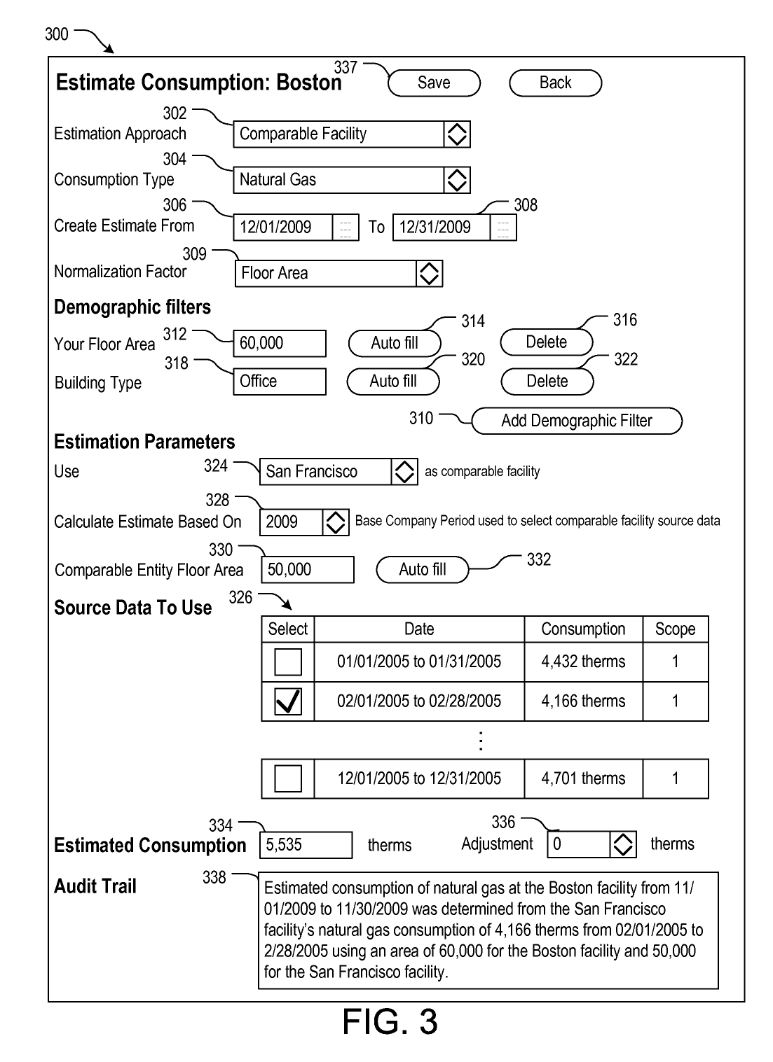

FIG. 3 shows a GUI 300 generated by server 112 for the client to submit the request to estimate resource consumption in one or more embodiments of the present disclosure. A menu 302 allows the client to select an estimation approach, such as a comparable facility approach and a leased space approach. A menu 304 allows the client to select a resource consumption type, such as electricity, natural gas, diesel, oil, or coal. Menus 306 and 308 allow the client to enter an estimation period.

Assuming the comparable facility estimation approach has been selected, a menu 309 allows the client to select a normalization factor. The normalization factor may be any of the demographic data, such as facility floor area, facility revenue, facility produced units. As described later, server 112 determines the resource consumption per day per unit of the normalization factor of a comparable facility, i.e., resource consumption during reporting period/(reporting period×normalization factor).

A button 310 allows the client to add a demographic filter for searching comparable facilities. Each demographic filter includes an editable field that may be automatically filled with its value from the demographic information in database 124. The selected normalization factor may appear as a demographic filter by default. An editable field 312 may be filled with the floor area value from of the demographic data of facility A in database 124. In case server 112 has not received a transmission of the demographic data for facility A, the client may fill editable field 312 with the floor area value. The client may also edit the value in editable field 312 to see how that impacts the estimated resource consumption. The new or edited value in editable field 312 may be saved into database 124 after the client selects a save button 337. An auto fill button 314 causes field 312 to revert back to the floor area value from database 124. A delete button 316 causes the corresponding demographic filter to be removed.

Assuming facility building type have been added as a demographic filter, an editable field 318 may be filled with the building type value from the demographic data of facility A in database 124. In case server 112 has not received a transmission of the demographic data for facility A, the client may fill editable field 318 with the building type value. The client may also edit the value in editable field 318 to see how that impacts the estimated resource consumption. The new or edited value in editable field 318 may be saved into database 124 after the client selects save button 337. An auto fill button 320 causes field 318 to revert back to the floor area value from the demographic data in database 124. A delete button 322 causes the corresponding demographic filter to be removed. As described later, server 112 determines comparable facilities based on the demographic filters.

The client may select a leased space estimation approach when the client occupies less than all the building space and the client has access to the total building consumption from its landlord. When a leased space estimation approach is selected, the request includes a resource consumption type, an estimation period, a total building area, a total building occupancy rate, a leased space area, and a total building consumption. The client may provide the information using menus similar to those shown in FIG. 3.

Referring back to FIG. 2, block 206 may be followed by block 208 when the client is using the comparable facility estimation approach. Block 206 may be followed by block 221 when the client is using the leased space estimation approach.

In block 208, in response to block 206, server 112 determines facilities B that are comparable to facility A based on their demographic data. When server 112 cannot find any comparable facility B, server 112 may access demographic data and resource consumption data of additional organizational units (hereafter “facilities C”) that are not part of the client's organizational hierarchy. The data may be located in a public database 126 (FIG. 1). Database 126 may contain information such as the US Energy Information Administration's Commercial Building Energy Consumption Survey available from the Department of Energy. Server 112 may store the data in database 124. Block 208 may be followed by block 210.

In block 210, server 112 transmits a list of the comparable facilities B or C to the client. Referring to FIG. 3, GUI 300 includes a menu 324 for the client to select a comparable facility. Referring to FIG. 2, block 210 is followed by block 212.

In block 212, server 112 receives a selection of a comparable facility (e.g., the San Francisco facility) from the list. Block 212 may be followed by block 214.

In block 214, in response to block 212, server 112 determines resource consumption items of the selected comparable facility from database 124. The resource consumption items may be limited to the consumption type specified for facility A. Block 214 may be followed by block 216.

In block 216, server 112 transmits a list of the resource consumption items to the client. Block 216 may be followed by block 218.

In block 218, server 112 receives a selection of a resource consumption item and estimation parameters. Referring to FIG. 3, GUI 300 includes a table 326 listing rows of the resource consumption items. Table 326 includes a first column to select a corresponding row of resource consumption item, a second column with reporting periods of the resource consumption items, a third column with values of resource consumption, and a fourth column with types of emission scope (e.g., as defined by the Carbon Disclosure Project, a nonprofit organization that collects climate change data). The client selects a resource consumption item by checking its select box.

The estimation parameters include a base period for the data of the selected comparable facility to be used in the estimation, and the normalization factor value (e.g., facility floor area) of the selected comparable facility. A menu 328 allows the client to select the base period for the data of the selected comparable facility. An editable field 330 may be filled with the normalization factor value from the demographic data of the selected comparable facility in database 124. The client may also edit the value in editable field 330 to see how that impacts the estimated resource consumption. The new or edited value in editable field 330 may be saved into database 124 after the client selects save button 337. An auto fill button 332 causes field 300 to revert back to the floor area value from database 124. Table 326 and field 330 are automatically updated when the client switches between comparable facilities in menu 324.

Referring to FIG. 2, block 218 may be followed by block 220.

In block 220, in response to block 218, server 112 determines an estimated resource consumption of facility A based on the selected resource consumption item and the estimation parameters. Server 112 determines the resource consumption per day per unit of the normalization factor of the selected resource item, i.e., resource consumption during reporting period/(reporting period×normalization factor during reporting period). For example, the normalization factor may be facility floor area or any other demographic data selected as the normalization factor including production units and revenue. Server 112 then determines the estimated resource consumption of facility A by multiplying the consumption per day per unit of the normalization factor of the selected comparable facility by the estimation period and the normalization factor of facility A. Block 220 may be followed by block 222.

In block 221, server 112 determines an estimated resource consumption of facility A based on the total building consumption, the building occupancy rate, the leased space area, and the total building area. Specifically, server 112 determines a product of (1) a first quotient of the total building consumption and the total building occupancy rate and (2) a quotient of the leased space area and the total building area, i.e., (total building consumption/total building occupancy rate)×(leased space/total building area). The division of the building occupancy rate ensures that the client only accounts for a portion of the consumption from the occupied spaces. Block 221 may be followed by block 222.

In block 222, server 112 transmits the estimated resource consumption of facility A to the client. Referring to FIG. 3, GUI 300 includes a non-editable field 334 with the estimated resource consumption. Field 334 is automatically updated when the client changes any of the estimation parameters. A field 336 also allows the client to add or subtract an adjustment to the estimate resource consumption. Referring back to FIG. 2, block 222 may be followed by block 224.

In block 224, server 112 receives an approval of the estimated resource consumption of facility A from the client. Referring to FIG. 3, GUI 300 includes button 337 for the client to approve/save the estimated resource consumption. Alternatively the client may loop back to any prior block or terminate the estimation process. Block 224 may be followed by block 226.

In block 226, in response to block 224, server 112 derives a measure of environmental impact from the estimated resource consumption. Server 112 records, in database 124, the measure of environmental impact with a system estimation flag, the estimated resource consumption with a system estimation flag, and an audit trail for the estimated resource consumption. The system estimation flag indicates that a value is based on a system estimate. Referring to FIG. 3, GUI 300 includes a field 338 filled with the audit trail of the estimate source consumption. Field 338 is automatically generated when the client changes any of the estimation parameters. Referring to FIG. 2, block 226 may be followed by block 228.

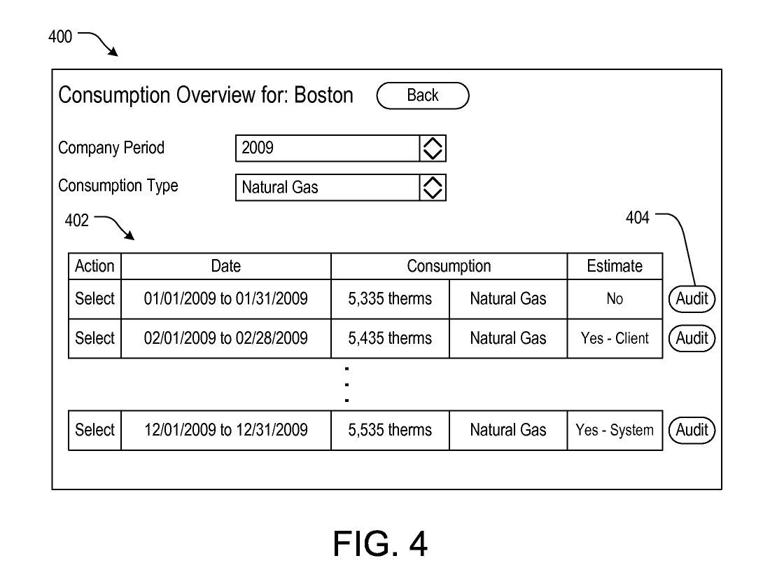

In block 228, server 112 then indicates, in any subsequently generated GUI (e.g., report) transmitted to the client, that the estimated resource consumption and/or the measure of environmental impact are estimated values. FIG. 4 shows a GUI 400 generated by server 112 for the client to see a report of resource consumption at facility A in one or more embodiments of the present disclosure. GUI 400 includes a table 402 with rows of resource consumption items of facility A. Table 402 includes a first column to select a corresponding row of resource consumption item, a second column with reporting dates of the resource consumption items, a third column with resource consumption amount and resource consumption type, and a fourth column indicating if a resource consumption item is not estimated, estimated by the system, or estimated by the client. Audit button 404 (only one is labeled) allows the client to bring up the audit trail for the corresponding estimated resource consumption item.

Various other adaptations and combinations of features of the embodiments disclosed are within the scope of the invention. Numerous embodiments are encompassed by the following claims.

1. A method for estimating a resource consumption of an organizational unit that is part of an entity, comprising:
receiving a transmission of demographic data and resource consumption data of other organizational units that are part of the entity and recording, using a programmed processor, the demographic data and the resource consumption data of the other organizational units into a database;
receiving a transmission of demographic data of the organizational unit and recording, using the programmed processor, the demographic data of the organizational unit into a database;
receiving a transmission of a request to estimate the resource consumption of the organizational unit;
in response to the request, determining, using the programmed processor, comparable organizational units to the organizational unit based on the demographic data of the organizational unit and the demographic data of the other organizational units;
transmitting a list of the comparable organizational units to the entity;
receiving a transmission of a selection of a comparable organizational unit;
in response to the selection of a comparable organizational unit, determining, using the programmed processor, resource consumption items of the selected comparable organizational unit;
transmitting a list of the resource consumption items to the entity;
receiving a transmission of a selection of a resource consumption item;
in response to the selection of a source consumption item, determining, using the programmed processor, an estimated resource consumption of the organizational unit based on the selected resource consumption item;
transmitting the estimated resource consumption to the entity; and
when a transmission of an approval of the estimated resource consumption is received:
processing, using the programmed processor, the estimated resource consumption to derive a measure of environmental impact; and
recording, using the programmed processor, the estimated resource consumption, the measure of environmental impact, and an audit trail for the estimated resource consumption in the database.

2. The method of claim 1, further comprising:
generating, using the programmed processor, a report including the estimated resource consumption or the measure of environmental impact, the report comprising an indication that the estimated resource consumption or the measure of environmental impact are estimates; and
transmitting the report to the entity.

3. The method of claim 1, further comprising:
transmitting the audit trail to the entity.

4. The method of claim 1, wherein the demographic data for each organizational unit includes an area of a facility, revenue generated from the facility, produced units at the facility, a usage of the facility, a type of the facility, an age of the facility, hours of operation of the facility, an employee count at the facility, a HVAC type at the facility, and a location of the facility.

5. The method of claim 1, wherein the request comprises a type of resource consumption, the type of resource consumption type being electricity, coal, oil, diesel, or natural gas.

6. The method of claim 1, wherein the request comprises a normalization factor selected from the demographic data, and the estimated resource consumption comprises a product of (1) a normalization factor value of the organizational unit, (2) an estimation period, and (3) a quotient of an amount of resource consumption from the selected resource consumption item divided by a product of (a) a normalization factor value of the selected comparable organizational unit and (b) a reporting period for the selected resource consumption item.

7. The method of claim 6, wherein the programmed processor determines the normalization factor values of the organizational unit and the selected comparable organizational unit from the demographic data of the organizational unit and the other organizational unit in the database.

8. The method of claim 6, wherein the request comprises the normalization factor values of the organizational unit and the selected comparable organizational unit provided by the entity.

9. The method of claim 6, wherein the request comprises the estimation period.

10. The method of claim 1, further comprising:
receiving a transmission of an adjustment to the estimate resource consumption; and
recoding, using the programmed processor, the estimated resource consumption with the adjustment in the database.

11. The method of claim 1, further comprising, in response to the request:
accessing demographic data and resource consumption data of additional organizational units derived from a public source;
determining, using the programmed processor, comparable additional organizational units to the organizational unit based on the demographic data of the organizational unit and the demographic data of the additional organizational units; and
incorporating, using the programmed processor, the comparable additional organizational units into the transmitted list.

12. The method of claim 1, further comprising:
receiving a transmission of an other request to estimate the resource consumption of the organizational unit, the other request comprising a total building area, a total building occupancy rate, a leased space area, and a total building consumption;
in response to the other request, determining, using the programmed processor, an other estimated resource consumption of the organizational unit as a product of (1) a first quotient of the total building consumption and the total building occupancy rate and (2) a quotient of the leased space area and the total building area;
transmitting the other estimated resource consumption to the entity; and
when a transmission of an approval of the other estimated resource consumption is received:
processing, using the programmed processor, the other estimated resource consumption to derive an other measure of environmental impact; and
recording, using the programmed processor, the other estimated resource consumption, the other measure of environmental impact, and an other audit trail for the other estimated resource consumption in the database.

13. A non-transitory computer-readable storage medium encoded with executable instructions for execution by a processor to estimate a resource consumption of an organizational unit that is part of an entity, the instructions comprising:
receiving a transmission of demographic data and resource consumption data of other organizational units that are part of the entity and recording the demographic data and the resource consumption data of the other organizational units into a database;
receiving a transmission of demographic data of the organizational unit and recording the demographic data of the organizational unit into a database;
receiving a transmission of a request to estimate the resource consumption of the organizational unit;
in response to the request, determining comparable organizational units to the organizational unit based on the demographic data of the organizational unit and the demographic data of the other organizational units;
transmitting a list of the comparable organizational units to the entity;
receiving a transmission of a selection of a comparable organizational unit;
in response to the selection of a comparable organizational unit, determining resource consumption items of the selected comparable organizational unit;
transmitting a list of the resource consumption items to the entity;
receiving a transmission of a selection of a resource consumption item;
in response to the selection of a source consumption item, determining an estimated resource consumption of the organizational unit based on the selected resource consumption item;
transmitting the estimated resource consumption to the entity; and
when a transmission of an approval of the estimated resource consumption is received:
processing the estimated resource consumption to derive a measure of environmental impact; and
recording the estimated resource consumption, the measure of environmental impact, and an audit trail for the estimated resource consumption in the database.

14. The non-transitory computer-readable storage medium of claim 13, wherein the instructions further comprise:
generating a report including the estimated resource consumption or the measure of environmental impact, the report comprising an indication that the estimated resource consumption or the measure of environmental impact are estimates; and
transmitting the report to the entity.

15. The non-transitory computer-readable storage medium of claim 13, wherein the instructions further comprise:
transmitting the audit trail to the entity.

16. The non-transitory computer-readable storage medium of claim 13, wherein the demographic data for each organizational unit includes an area of a facility, revenue generated from the facility, produced units at the facility, a usage of the facility, a type of the facility, an age of the facility, hours of operation of the facility, an employee count at the facility, a HVAC type at the facility, and a location of the facility.

17. The non-transitory computer-readable storage medium of claim 13, wherein the request comprises a type of resource consumption, the type of resource consumption type being electricity, coal, oil, diesel, or natural gas.

18. The non-transitory computer-readable storage medium of claim 13, wherein the request comprises a normalization factor selected from the demographic data, and the estimated resource consumption comprises a product of (1) a normalization factor value of the organizational unit, (2) an estimation period, and (3) a quotient of an amount of resource consumption from the selected resource consumption item divided by a product of (a) a normalization factor value of the selected comparable organizational unit and (b) a reporting period for the selected resource consumption item.

19. The non-transitory computer-readable storage medium of claim 13, wherein the programmed processor determines the normalization factor values of the organizational unit and the selected comparable organizational unit from the demographic data of the organizational unit and the other organizational unit in the database.

20. The non-transitory computer-readable storage medium of claim 19, wherein the request comprises the normalization factor values of the organizational unit and the selected comparable organizational unit provided by the entity.

21. The non-transitory computer-readable storage medium of claim 19, wherein the request comprises the estimation period.

22. The non-transitory computer-readable storage medium of claim 13, wherein the instructions further comprise:
receiving a transmission of an adjustment to the estimate resource consumption; and
recoding, using the programmed processor, the estimated resource consumption with the adjustment in the database.

23. The non-transitory computer-readable storage medium of claim 13, wherein the instructions further comprise, in response to the request:
accessing demographic data and resource consumption data of additional organizational units derived from a public source;
determining, using the programmed processor, comparable additional organizational units to the organizational unit based on the demographic data of the organizational unit and the demographic data of the additional organizational units; and
incorporating, using the programmed processor, the comparable additional organizational units into the transmitted list.

24. The non-transitory computer-readable storage medium of claim 13, wherein the instructions further comprise:
receiving a transmission of an other request to estimate the resource consumption of the organizational unit, the other request comprising a total building area, a total building occupancy rate, a leased space area, and a total building consumption;
in response to the other request, determining, using the programmed processor, an other estimated resource consumption of the organizational unit as a product of (1) a first quotient of the total building consumption and the total building occupancy rate and (2) a quotient of the leased space area and the total building area;
transmitting the other estimated resource consumption to the entity; and
when a transmission of an approval of the other estimated resource consumption is received:
processing, using the programmed processor, the other estimated resource consumption to derive an other measure of environmental impact; and
recording, using the programmed processor, the other estimated resource consumption, the other measure of environmental impact, and an other audit trail for the other estimated resource consumption in the database.
